(19) United States
(12) Patent Application Publication
(10) Pub. No.: US 2024/0162461 A1
(43) Pub. Date: May 16, 2024

(54) FUEL CELL SYSTEM

(71) Applicant: HONDA MOTOR CO., LTD., Tokyo (JP)

(72) Inventor: Kazunori FUKUMA, WAKO-SHI (JP)

(21) Appl. No.: 18/388,320

(22) Filed: Nov. 9, 2023

(30) Foreign Application Priority Data
Nov. 14, 2022 (JP) 2022-181683

(51) Int. Cl. H01M 8/0438; H01M 8/04119; H01M 8/0444; H01M 8/04537

(52) U.S. Cl. CPC H01M 8/04388; H01M 8/04164; H01M 8/04447; H01M 8/04552

(57) ABSTRACT

A fuel cell system includes a gas circulation path configured to return a gas that is discharged from a fuel cell back to the fuel cell, a volume adjuster configured to increase or decrease a volume of the gas in the gas circulation path, a voltage sensor configured to detect a voltage of the fuel cell, a volume control unit configured to control the volume adjuster to increase the volume of the gas, and an estimation unit configured to estimate an impurity amount or an impurity concentration of the gas from a voltage change of the fuel cell due to an increase in the volume of the gas.

### CROSS-REFERENCE TO RELATED APPLICATIONS

This application is based upon and claims the benefit of priority from Japanese Patent Application No. 2022-181683 filed on Nov. 14, 2022, the contents of which are incorporated herein by reference.

### BACKGROUND OF THE INVENTION

### Field of the Invention

The present invention relates to a fuel cell system.

### Description of the Related Art

In a fuel cell system, gas that has been supplied to a fuel cell may be circulated. It is known that when power generation is performed for a long period of time in such a fuel cell system, impurities (impurity gas) gradually accumulate in the circulating gas and adversely affect the power generation performance of the fuel cell. Therefore, a purging process is performed to discharge the impurities to the outside in a state in which the impurities are accumulated to some extent.

JP 2008-146877 A discloses a method in which the relationship between the current density of a fuel cell and the rate at which impurities accumulate is determined in advance, the current density of the fuel cell is detected at predetermined time intervals, and the amount of accumulated impurities is estimated, in order to appropriately perform a purging process.

### SUMMARY OF THE INVENTION

However, in the method disclosed in JP 2008-146877 A, there is a problem in that the error increases as the purge interval increases, and there is room for further improvement.

The present invention has the object of solving the aforementioned problem.

According to one aspect of the present disclosure, there is provided a fuel cell system including a gas circulation path configured to supply a gas that has been discharged from a fuel cell back to the fuel cell, a volume adjuster configured to increase or decrease a volume of the gas in the gas circulation path, a voltage sensor configured to detect a voltage of the fuel cell, a volume control unit configured to control the volume adjuster to increase the volume of the gas, and an estimation unit configured to estimate an impurity amount or an impurity concentration of the gas from a voltage change of the fuel cell due to an increase in the volume of the gas.

According to the fuel cell system of the present invention, the impurity concentration can be accurately obtained during the operation, and the loss of the fuel gas or the oxygen-containing gas can be suppressed by reducing unnecessary purging.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram of a fuel cell system according to an embodiment;

FIG. 2A is a diagram showing a water level in a gas-liquid separator before the volume of a hydrogen gas in a hydrogen circulation path is increased;

FIG. 2B is a diagram showing a water level in the gas-liquid separator after the volume of the hydrogen gas in the hydrogen circulation path is increased;

FIG. 3 is a graph showing the relationship between a cell voltage of a fuel cell and an impurity concentration of the fuel gas;

FIG. 4 is a flowchart showing the operation of a control unit of FIG. 1;

FIG. 5A is a graph showing a measurement result of a cell voltage according to an experimental example;

FIG. 5B is a graph showing the relationship between the impurity concentration and a voltage change (dv) obtained in the experimental example; and

FIG. 6 is an explanatory diagram of a gas-liquid separator according to a third modification of the embodiment.

### DETAILED DESCRIPTION OF THE INVENTION

### Embodiment

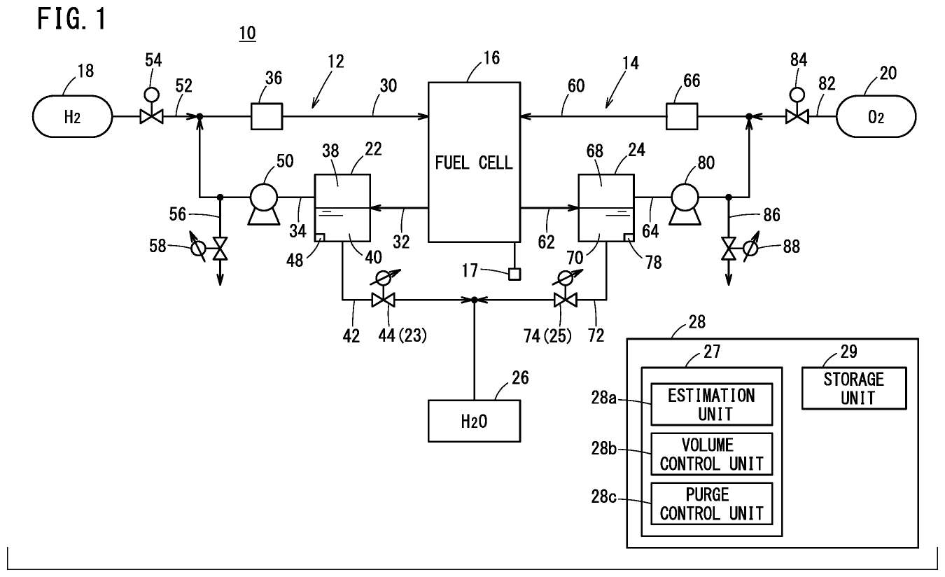

A fuel cell system 10 according to the embodiment shown in FIG. 1 is a system that circulates a fuel gas and uses the fuel gas for electrical power generation. Here, an example in which hydrogen is used as the fuel gas and oxygen (pure oxygen) is used as an oxygen-containing gas will be described. In the illustrated configuration example, the fuel cell system 10 is configured such that hydrogen is supplied from a hydrogen circulation path 12 and the oxygen is supplied from an oxygen circulation path 14. Such a fuel cell system 10 can operate even in an environment in which air is not supplied as the an oxidant gas. The fuel cell system 10 may be configured to take in air as the oxygen-containing gas and circulate only hydrogen through the hydrogen circulation path 12.

As shown in FIG. 1, the fuel cell system 10 mainly includes the hydrogen circulation path 12, the oxygen circulation path 14, a fuel cell 16, a hydrogen tank 18, an oxygen tank 20, a first gas-liquid separator 22, a first volume adjuster 23, a second gas-liquid separator 24, a second volume adjuster 25, a water tank 26, and a control device 28.

The fuel cell 16 is, for example, a solid polymer electrolyte fuel cell (PEFC), a phosphoric acid fuel cell (PAFC), a molten carbonate fuel cell (MCFC), a solid oxide fuel cell (SOFC), or an alkaline fuel cell (AFC). Here, a description will be given based on an example in which a solid polymer electrolyte fuel cell (PEFC) is adopted as the fuel cell 16.

The fuel cell 16 includes a membrane electrode assembly in which a polymer electrolyte membrane is interposed between an anode and a cathode. The membrane electrode assembly is sandwiched between separators to constitute one power generation cell. The fuel cell 16 includes a fuel cell stack in which several tens to several hundreds of power generation cells are stacked. Hydrogen is supplied to the anode of each of the power generation cells. Oxygen is supplied to the cathode of each of the power generation cells. The fuel cell 16 generates electrical power by electrochemical reactions between hydrogen and oxygen. A voltage sensor 17 is connected to a power output terminal of the fuel cell 16. The voltage sensor 17 detects a power generation voltage of the fuel cell 16. A detection value of the voltage sensor 17 is input to the control device 28. The voltage sensor 17 may be provided in the control device 28.

Hydrogen is supplied to the fuel cell 16 through the hydrogen circulation path 12, and oxygen is supplied to the fuel cell 16 through the oxygen circulation path 14. The hydrogen circulation path 12 is a path through which hydrogen discharged from the fuel cell 16 is supplied again to the fuel cell 16. The hydrogen circulation path 12 includes an anode supply path 30, an anode discharge path 32, and an anode circulation flow path 34. The anode supply path 30 is a flow path for supplying hydrogen to the anode of the fuel cell 16. Although not particularly limited, a heat exchanger 36 may be disposed in the anode supply path 30. The heat exchanger 36 maintains the temperature of hydrogen supplied to the fuel cell 16 at a predetermined temperature.

The anode discharge path 32 is a flow path for discharging hydrogen from the anode of the fuel cell 16. A fluid in which hydrogen and water generated by the electrochemical reactions are mixed flows through the anode discharge path 32. The first gas-liquid separator 22 is connected to an end portion of the anode discharge path 32.

The first gas-liquid separator 22 separates hydrogen and liquid water. The first gas-liquid separator 22 may be a gravity separator that separates hydrogen and water by using gravity. The first gas-liquid separator 22 may be a centrifugal separator that separates hydrogen and water by using centrifugal force. The hydrogen is collected in a gas recovery unit 38 of the first gas-liquid separator 22, and the separated water is collected in a water storage unit 40 of the first gas-liquid separator 22.

The hydrogen collected in the gas recovery unit 38 is discharged from the first gas-liquid separator 22 through the anode circulation flow path 34. On the other hand, the water stored in the water storage unit 40 is drained into the water tank 26 through a first water drainage passage 42. Drainage from the first gas-liquid separator 22 is performed by a first drainage valve 44 (the first volume adjuster 23).

The internal volume of the first gas-liquid separator 22 is the sum of the volume of hydrogen and the volume of water. When water is drained from the first gas-liquid separator 22, the volume of hydrogen is increased by the amount of discharged water. That is, the first drainage valve 44 constitutes the first volume adjuster 23 that adjusts the volume of hydrogen through the drainage of the first gas-liquid separator 22.

The first gas-liquid separator 22 may include a first water amount sensor 48 in order to detect the drainage amount of water (the amount of increase in the volume of hydrogen). The detection value of the first water amount sensor 48 is input to a volume control unit 28b of the control device 28. Note that the first water amount sensor 48 is not essential, and instead of the first water amount sensor 48, a flow rate sensor may be provided in the first water drainage passage 42 of the first gas-liquid separator 22.

The anode circulation flow path 34 is a flow path that returns the hydrogen discharged from the first gas-liquid separator 22 to the anode supply path 30. The anode circulation flow path 34 may include a pump 50. The pump 50 circulates hydrogen inside the hydrogen circulation path 12. The hydrogen that has passed through the anode circulation flow path 34 is supplied to the anode of the fuel cell 16 through the anode supply path 30. The hydrogen tank 18 is connected to the hydrogen circulation path 12 through a hydrogen replenishment path 52.

The hydrogen tank 18 stores hydrogen in a compressed state. Hydrogen in the hydrogen tank 18 is supplied to the hydrogen circulation path 12 through the hydrogen replenishment path 52. The hydrogen replenishment path 52 is connected to the anode supply path 30 on an upstream side of the heat exchanger 36. The hydrogen replenishment path 52 is provided with a pressure reducing valve 54. The pressure reducing valve 54 reduces the pressure of the high pressure hydrogen in the hydrogen tank 18 and supplies the hydrogen to the hydrogen circulation path 12. The pressure reducing valve 54 maintains the pressure in the hydrogen circulation path 12 at a predetermined value. Therefore, when the amount of hydrogen in the hydrogen circulation path 12 decreases with the partial consumption of hydrogen by the fuel cell 16, the pressure reducing valve 54 supplies hydrogen in the hydrogen tank 18 to the hydrogen circulation path 12 to maintain the pressure in the hydrogen circulation path 12 constant. When the drainage from the first gas-liquid separator 22 is performed, the pressure reducing valve 54 supplies the hydrogen in the hydrogen tank 18 to the hydrogen circulation path 12 to keep the pressure in the hydrogen circulation path 12 constant.

A hydrogen release path 56 and a first purge valve 58 are connected to the hydrogen circulation path 12. The first purge valve 58 is provided in the hydrogen release path 56. The first purge valve 58 is operated under the control of a purge control unit 28c and discharges (purges) the hydrogen in the hydrogen circulation path 12 to the outside.

The oxygen circulation path 14 is a path for supplying the oxygen discharged from the fuel cell 16 to the fuel cell 16 again. The oxygen circulation path 14 includes a cathode supply path 60, a cathode discharge path 62, the second gas-liquid separator 24, and a cathode circulation path 64. The cathode supply path 60 is a flow path for supplying oxygen to the cathode of the fuel cell 16. The cathode supply path 60 has a heat exchanger 66. The oxygen supplied to the fuel cell 16 is maintained at a predetermined temperature by the heat exchanger 66.

The cathode discharge path 62 discharges hydrogen containing water from the fuel cell 16. The second gas-liquid separator 24 is connected to the downstream side of the cathode discharge path 62. The second gas-liquid separator 24 separates water from oxygen. The oxygen separated by the second gas-liquid separator 24 is returned to the cathode supply path 60 through a pump 80 of the cathode circulation path 64. The water recovered by the second gas-liquid separator 24 is drained into the water tank 26 through a second drainage passage 72.

The second gas-liquid separator 24 is configured in the same manner as the first gas-liquid separator 22, and includes a gas recovery unit 68, a water storage unit 70, and a second water amount sensor 78. The second gas-liquid separator 24 may increase the volume of oxygen therein through the drainage. Drainage from the second gas-liquid separator 24 is performed by a second drainage valve 74 that is controlled by the volume control unit 28b of the control device 28. That is, the second drainage valve 74 constitutes the second volume adjuster 25 that increases or decreases the volume of oxygen in the oxygen circulation path 14.

The oxygen tank 20 supplies oxygen to the oxygen circulation path 14 through an oxygen replenishment path 82. The oxygen replenishment path 82 is connected to the cathode supply path 60 on an upstream side of the heat exchanger 66. The oxygen replenishment path 82 is provided with a pressure reducing valve 84. The pressure reducing valve 84 reduces the pressure of oxygen in a high pressure state in the oxygen tank and supplies the oxygen to the oxygen circulation path 14. The pressure reducing valve 84 maintains the pressure of the oxygen circulation path 14 at a predetermined value. That is, when the amount of oxygen in the oxygen circulation path 14 decreases with the partial consumption of oxygen by the fuel cell 16, the pressure reducing valve 84 supplies oxygen in the oxygen tank 20 to the oxygen circulation path 14 to maintain the pressure in the oxygen circulation path 14 constant. In addition, when the drainage from the second gas-liquid separator 24 is performed, the pressure reducing valve 84 supplies oxygen to the oxygen circulation path 14 to keep the pressure in the oxygen circulation path 14 constant.

An oxygen release path 86 and a second purge valve 88 are connected to the oxygen circulation path 14. The second purge valve 88 is provided in the oxygen release path 86. The second purge valve 88 is operated under the control of the purge control unit 28c of the control device 28 and discharges (purges) the oxygen in the oxygen circulation path 14 to the outside.

The control device 28 includes, for example, a computation unit (processing unit) 27 and a storage unit 29. The computation unit 27 may be constituted by a processor such as a Central Processing Unit (CPU) and a Graphics Processing Unit (GPU), and more specifically, processing circuitry.

The computation unit 27 includes an estimation unit 28a, the volume control unit 28b, and the purge control unit 28c. The estimation unit 28a, the volume control unit 28b, and the purge control unit 28c can be realized by programs stored in the storage unit 29 being executed by the computation unit 27.

The estimation unit 28a estimates the amount of impurities in the hydrogen circulation path 12 and the oxygen circulation path 14, from the amount of changes in the voltage, i.e., a voltage change amount dV (voltage change) of the fuel cell 16 due to the changes in the volume of hydrogen in the hydrogen circulation path 12 and the changes in the volume of oxygen in the oxygen circulation path 14.

The volume control unit 28b increases the volume of the hydrogen (gas) in the first gas-liquid separator 22 by a predetermined amount by controlling the first drainage valve 44 based on the detection value of the first water amount sensor 48 to drain the water in the first gas-liquid separator 22. In addition, the volume control unit 28b increases the volume of the oxygen (gas) in the second gas-liquid separator 24 by a predetermined amount, by controlling the second drainage valve 74 based on the detection value of the second water amount sensor 78 to drain the water in the second gas-liquid separator 24.

In the case where the amount of impurity in the hydrogen circulation path 12 and the oxygen circulation path 14 exceeds a predetermined value, the purge control unit 28c controls the first purge valve 58 and the second purge valve 88 to discharge the hydrogen in the hydrogen circulation path 12 and the oxygen in the oxygen circulation path 14 to the outside.

At least a part of the estimation unit 28a, the volume control unit 28b, and the purge control unit 28c may be realized by integrated circuits such as an Application Specific Integrated Circuit (ASIC) and a Field-Programmable Gate Array (FPGA). At least a part of the estimation unit 28a, the volume control unit 28b, and the purge control unit 28c may be configured by an electronic circuit including a discrete device.

The storage unit 29 may be configured by a volatile memory (not shown), and a non-volatile memory (not shown). As the volatile memory, there may be cited, for example, a Random Access Memory (RAM). The volatile memory is used as a working memory of the processor, and temporarily stores data or the like required for processing or calculations. As the non-volatile memory, there may be cited, for example, a Read Only Memory (ROM), a flash memory, or the like. The non-volatile memory is used as a storage memory, and stores therein programs, tables, maps, approximate functions, parameters thereof, and the like. At least a portion of the storage unit 29 may be provided in the aforementioned processor, the integrated circuit, or the like.

The fuel cell system 10 of the present embodiment is configured as described above. Hereinafter, an operation of detecting the amount of impurities in the hydrogen circulation path 12 and the oxygen circulation path 14 in the fuel cell system 10, will be described. The voltage (power generation voltage) of the fuel cell 16 decreases, as the amount of impurities in the paths including the anode portion inside the fuel cell 16, the anode supply path 30, the anode discharge path 32, and the anode circulation flow path 34, which constitute the hydrogen circulation path 12, increases. Further, the voltage (power generation voltage) of the fuel cell 16 decreases, as the amount of impurities in the paths including the cathode portion inside the fuel cell 16, the cathode supply path 60, the cathode discharge path 62, and the cathode circulation path 64, which constitute the oxygen circulation path 14, increases.

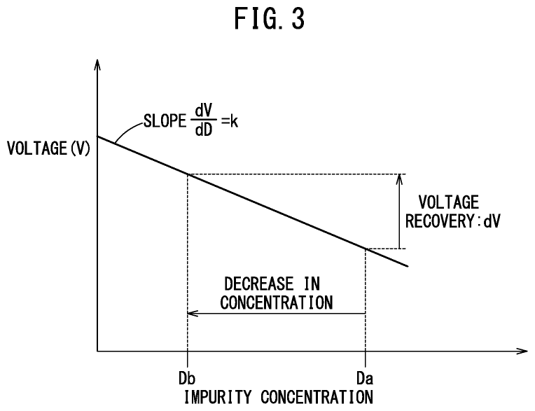

For example, the voltage of the fuel cell 16 decreases as shown in FIG. 3 due to an increase in the amount of impurities (the volume of the impurity gas) in the hydrogen circulation path 12. FIG. 3 shows changes under the condition that the output current value of the fuel cell 16 is constant. As shown in the figure, the voltage of the fuel cell 16 changes depending on the impurity concentration in the hydrogen circulation path 12. Therefore, the fuel cell 16 generates a predetermined voltage change amount dV [V] with respect to a predetermined change in the impurity concentration in the hydrogen circulation path 12. Also, the voltage of the fuel cell 16 also decreases as the amount of impurities in the oxygen circulation path 14 increases, in a similar manner as shown in FIG. 3. The voltage of the fuel cell 16 generates the predetermined voltage change amount dV [V] with respect to a predetermined change in the impurity concentration in the oxygen circulation path 14. Although the voltage of the fuel cell 16 decreases due to deterioration of the power generation cells as well, if the deterioration is within an allowable range, the voltage change amount dV [V] of the fuel cell 16 takes a predetermined value with respect to a predetermined change in the impurity concentration.

Here, the volume of the hydrogen circulation path 12 is assumed to be Va [L]. It is assumed that the amount of impurities (impurity amount, volume of impurity gas) M [L] is accumulated. At this time, the impurity concentration is Da=M/Va.

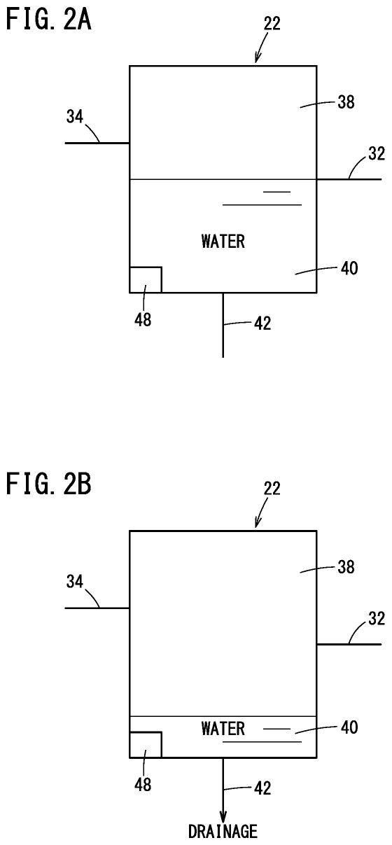

Next, as shown in FIGS. 2A and 2B, a case is considered where the volume of the hydrogen circulation path 12 is increased to Vb by the water draining operation of the first gas-liquid separator 22. Since the water draining operation of the first gas-liquid separator 22 is completed in a relatively short time, the impurity amount M can be regarded as substantially constant.

As shown in FIG. 3, when the impurity concentration decreases from Da to db, the voltage of the fuel cell 16 changes. Although the value of the voltage changes due to the deterioration of the power generation cell and the temperature change, the voltage change amount dV is relatively less affected by the deterioration of the power generation cell and the temperature change. Therefore, in the present embodiment, the impurity amount is estimated based on the voltage change amount dV. When a slope of the straight line in FIG. 3 is denoted by k and the amount of change in the impurity concentration is denoted by (Da-db), the voltage change amount dV of the fuel cell 16 due to the change in the impurity concentration is expressed by a following equation (1).

dV=k(db−Da)=kM(1/Vb−1/Va) (1)

The following values are obtained in advance: a slope k of a straight line in FIG. 3 showing the relationship between the impurity concentration and the voltage of the fuel cell 16; and the values of the volume Va before the water draining operation and the volume Vb after the water draining operation. Then, the impurity amount M can be obtained from the voltage change amount dV.

For convenience of explanation, the above-described relational expression is simplified on the assumption that the voltage of the fuel cell 16 linearly changes with respect to the impurity concentration D. The present embodiment is not limited thereto. An approximate function (or table) dV=f(M, V) indicating the relationship between the impurity amount M, the volume V, and the voltage change amount dV of the fuel cell 16 may be used. In this case, the impurity amount M is obtained by substituting the measured value of the voltage change amount dV and the values of the volumes Va and Vb into the approximate function dV=f(M, V) and solving the equation for the impurity amount M. The relationship between the impurity concentration D and the voltage change amount dV may also change due to deterioration of the power generation cell. In this case, the accuracy may be further improved by using an approximate function dV=f(M, V, Z) (or a table) including the amount of deterioration Z of the power generation cell as a variable.

Although the hydrogen circulation path 12 has been described above, the impurity amount M can be estimated by the same method for the oxygen circulation path 14. In this case, the parameters k, Va, and Vb of the equation (1) indicating the relationship of the voltage change amount dV of the fuel cell 16 are obtained in advance, with respect to the oxygen circulation path 14. Then, the impurity amount M in the oxygen circulation path 14 can be obtained by measuring the voltage change amount dV of the fuel cell 16 at the timing of the water draining operation of the second gas-liquid separator 24. It is preferable for the estimation of the impurity amount M in the oxygen circulation path 14 to be performed with a time lag from the estimation of the impurity amount M in the hydrogen circulation path 12.

Hereinafter, the operation of the fuel cell system 10 of the present embodiment will be described.

As shown in FIG. 1, in the fuel cell system 10, hydrogen is supplied to the anode of the fuel cell 16 through the hydrogen circulation path 12, and oxygen is supplied to the cathode of the fuel cell 16 through the oxygen circulation path 14. The fuel cell 16 generates electric power by reacting hydrogen and oxygen. The oxygen supplied from the oxygen tank and the hydrogen supplied from the hydrogen tank 18 contain a trace amount of impurities. When the fuel cell 16 is operated for a long period of time, impurities contained in hydrogen are accumulated in the hydrogen circulation path 12. In addition, impurities contained in oxygen may permeate through the electrolyte membrane and be accumulated in the hydrogen circulation path 12. Similarly, impurities are also accumulated in the oxygen circulation path 14. As the impurities accumulate, the voltage of the fuel cell 16 decreases.

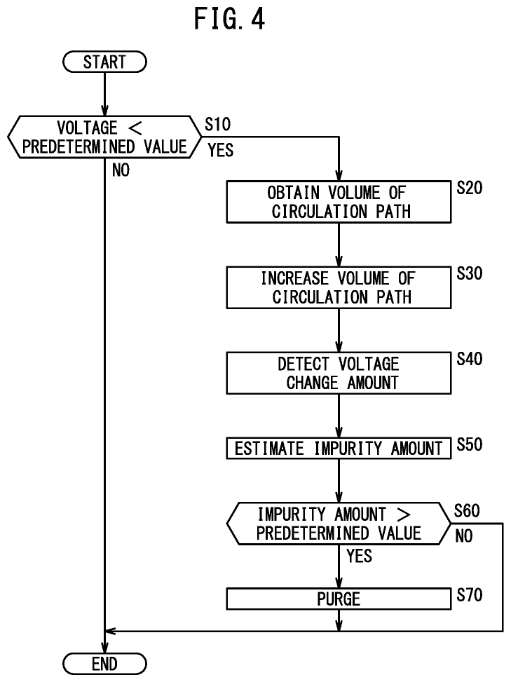

In order to prevent the voltage drop of the fuel cell 16 due to the accumulation of impurities, the control device 28 performs the estimation of the impurity amount M and the purging process shown in FIG. 4 for each of the hydrogen circulation path 12 and the oxygen circulation path 14. Hereinafter, the process of estimating the impurity amount M will be described using the hydrogen circulation path 12 as an example.

In step S10, the control device 28 determines whether or not the voltage (generated voltage) of the fuel cell 16 at a predetermined current has fallen below a predetermined value. In step S10, when the voltage of the fuel cell 16 is equal to or higher than the predetermined value (S10: NO), the control device 28 determines that the estimation of the impurity amount M and the purging process are unnecessary, and ends the process. On the other hand, if the voltage of the fuel cell 16 is less than the predetermined value in step S10, the control device 28 advances the process to step S20.

In step S20, the control device 28 obtains the volume of hydrogen in the hydrogen circulation path 12 from the detection value of the first water amount sensor 48.

Next, in step S30, the volume control unit 28b of the control device 28 controls the first drainage valve 44 to drain a predetermined amount of water from the first gas-liquid separator 22. As a result, the volume of hydrogen in the hydrogen circulation path 12 increases from the volume Va to the volume Vb. Thereafter, the process proceeds to step S40.

Next, in step S40, the estimation unit 28a of the control device 28 acquires the voltage of the fuel cell 16 through the voltage sensor 17. After that, the estimation unit 28a obtains the voltage change amount dV (absolute value) between the voltage of the fuel cell 16 obtained in step S10 and the voltage of the fuel cell 16 after the volume is increased.

Next, in step S50, the estimation unit 28a of the control device 28 substitutes the voltage change amount dV of the fuel cell 16, the slope k determined in advance, the volume Va obtained in step S20, and the volume Vb obtained in step S30 into the equation dV=kM(1/Vb−1/Va), and solves the equation for M to estimate the impurity amount M of the hydrogen circulation path 12. It should be noted that the estimation of the impurity amount M in step S50 may be performed using an approximate function obtained in advance and indicating a relationship between the voltage change amount dV of the fuel cell 16, the impurity amount M, and the volumes Va and Vb.

Next, in step S60, the control device 28 determines whether or not the impurity amount M estimated in step S50 exceeds a predetermined value. When the impurity amount M is equal to or less than the predetermined value (S60: NO), the control device 28 determines that the hydrogen purge is unnecessary, and ends the process. On the other hand, when the impurity amount M exceeds the predetermined value (S60: YES), the control device 28 advances the process to step S70.

In step S70, the purge control unit 28c of the control device 28 controls the first purge valve 58 to discharge (purge) the hydrogen gas in the hydrogen circulation path 12 to the outside. The purge control unit 28c may adjust the opening time or the purge amount of the first purge valve 58 based on the impurity amount M estimated in step S50. As described above, the estimation of the impurity amount M and the purging process for the hydrogen circulation path 12 are completed.

The estimation of the impurity amount M and the purging process for the oxygen circulation path 14 are performed in the same manner as described above. In this case, in step S20, the control device 28 obtains the volume of oxygen in the oxygen circulation path 14 from the detection value of the second water amount sensor 78. In step S30, the volume control unit 28b of the control device 28 controls the second drainage valve 74 to drain a predetermined amount of water from the second gas-liquid separator 24. Next, in step S50, the estimation unit 28a of the control device 28 substitutes the voltage change amount dV of the fuel cell 16, the slope k determined in advance, the volume Va obtained in step S20, and the volume Vb obtained in step S30 into the equation dV=kM(1/Vb−1/Va), and solves the equation for M to estimate the impurity amount M of the oxygen circulation path 14. In step S60, when the control device 28 determines that the impurity amount M in the oxygen circulation path 14 exceeds the predetermined value, the purge control unit 28c of the control device 28 controls the second purge valve 88 to discharge (purge) the oxygen in the oxygen circulation path 14 to the outside in step S70.

As described above, the fuel cell system 10 according to the present embodiment can reduce the loss of hydrogen and oxygen by not performing purging when the impurity amount M is equal to or less than the predetermined value. In addition, since the voltage drop of the fuel cell 16 due to the influence of impurities can be determined separately from other factors, it is possible to suppress an error in the estimated value of the impurity amount M. In the above-described method, it is obvious that the same result can be obtained by replacing the impurity amount M with the impurity concentration D obtained by dividing the impurity amount M by the volume V of the circulation path.

### Experimental Example

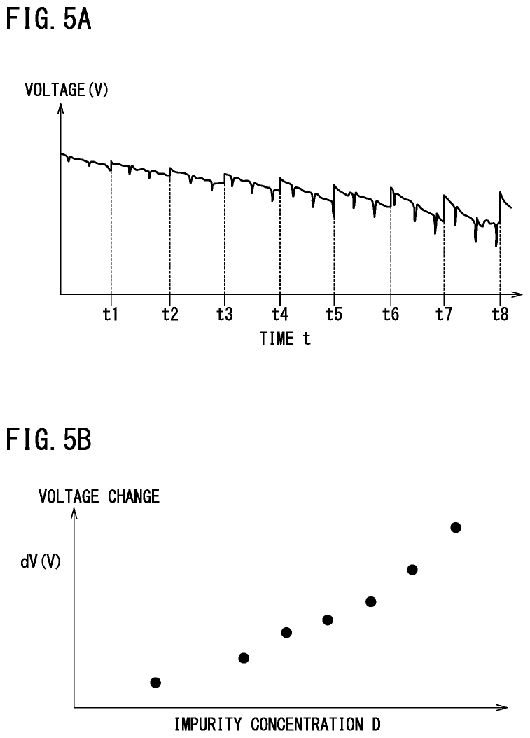

In the experimental example, the fuel cell system 10 shown in FIG. 1 was actually operated. In the experimental example, a voltage change of the fuel cell 16 over time was measured. At times t1, t2, t3, t4, t5, t6, t7, and t8 in FIG. 5A, respectively, the operation of increasing the volume in the hydrogen circulation path 12 by 10% was performed. The operation for increasing the volume was performed by discharging water from the first gas-liquid separator 22. The impurity concentration D in the hydrogen circulation path 12 was measured by an analyzer.

As shown in FIG. 5A, the voltage of the fuel cell 16 showed a tendency to decrease in proportion to time from the start of the experiment. At the timing when the volume of the hydrogen circulation path 12 was increased, a change (increase) in voltage occurred.

Next, the relationship between the voltage change amount dV generated by the increase in the volume of the hydrogen circulation path 12 and the impurity concentration D was obtained. The result is shown in FIG. 5B. As shown in FIG. 5B, the result was obtained in which the voltage change amount dV increased in accordance with an increase in impurity concentration D. From this result, it was confirmed that the impurity amount M can be estimated from the increase in the volume of the hydrogen circulation path 12 and the voltage change amount dV.

Hereinafter, a modification of the fuel cell system 10 of the present embodiment will be described.

### Modification 1 of Embodiment

Although the fuel cell system 10 of FIG. 1 has been described as having the oxygen circulation path 14, the present embodiment is not limited to this. The fuel cell system 10 may be configured to take in air from the atmosphere as an oxygen-containing gas. In this case, the oxygen-containing gas is discharged into the atmosphere from the cathode discharge path 62 without being circulated, and the fuel cell system 10 does not include the oxygen circulation path 14. In such a fuel cell system 10, estimation of the impurity amount M and purging of hydrogen may be performed only for the hydrogen circulation path 12.

### Modification 2 of Embodiment

Although FIG. 4 shows an example in which purging is performed simultaneously with estimation of the impurity amount M, the present embodiment is not limited to such an aspect. The control device 28 may estimate a time period before the impurity amount M exceeds a predetermined value based on a plurality of estimation results of the impurity amount M, and may perform purging by using the time period. That is, the purge control unit 28c of the control device 28 obtains an approximate function M=f(t) showing a change in the impurity amount M with respect to time based on the data of the impurity amount M and time. Then, the purge control unit 28c obtains the time at which the impurity amount M exceeds the predetermined value from the approximate function M=f(t), and performs the purging process of the hydrogen circulation path 12 or the oxygen circulation path 14 at the time.

The present modification has an advantage that the timing of purging the hydrogen circulation path 12 (the oxygen circulation path 14) is not restricted by the timing of draining the water from the first gas-liquid separator 22 (the second gas-liquid separator 24). In the present modification, the loss of hydrogen and oxygen can be further suppressed by purging at an optimal timing.

### Modification 3 of Embodiment

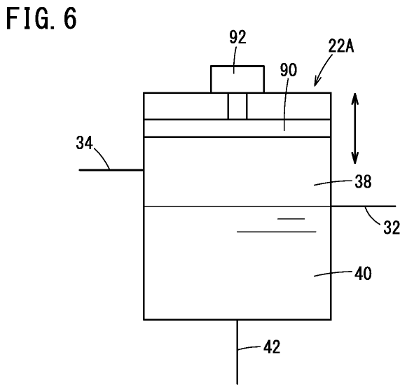

As shown in FIG. 6, the present modification is another configuration example of the first gas-liquid separator 22 of FIG. 1. A first gas-liquid separator 22A of the present modification includes a piston 90 provided in the gas recovery unit 38 and an actuator 92 that drives the piston 90. The piston 90 moves along an inner wall of the gas recovery unit 38 to decrease or increase the volume of the gas recovery unit 38. The actuator 92 is controlled by the volume control unit 28b (see FIG. 1) to change the position of the piston 90. The first gas-liquid separator 22A of the present modification may have a bellows-shaped wall instead of the piston 90, and the actuator 92 may expand and contract the bellows to decrease or increase the volume.

In this modification, instead of draining water from the first gas-liquid separator 22, the operation by the actuator 92 of the first gas-liquid separator 22A can increase the volume of hydrogen in the hydrogen circulation path 12. The first gas-liquid separator 22A according to the present modification can increase the volume of the hydrogen-circulating path 12 even when a sufficient amount of water is not stored in the first gas-liquid separator 22A. The present modification can also be applied to the second gas-liquid separator 24 (see FIG. 1) in the same manner.

### Modification 4 of Embodiment

In the example of FIG. 1, the volume control unit 28b changes the volume of the gas in the first gas-liquid separator 22 and the second gas-liquid separator 24, but the present embodiment is not limited thereto. In the present modification, the volume control unit 28b may include cylinders, pistons, and actuators configured to drive the pistons which are provided separately from the first gas-liquid separator 22 and the second gas-liquid separator 24.

### Modification 5 of Embodiment

In the present modification, an example in which the fuel cell system 10 of FIG. 1 is combined with a water electrolysis system to form a regenerative fuel cell system will be described. The regenerative fuel cell system is a system in which water generated by power generation of the fuel cell system 10 is used to generate hydrogen and oxygen using a water electrolysis system, and the hydrogen and oxygen are used again for power generation of the fuel cell system 10. Such a regenerative fuel cell system is suitably used for storing surplus electrical power generated in a power generation system such as a solar power generation system or a wind power generation system.

The water electrolysis system of the regenerative fuel cell system includes a water electrolysis stack for electrochemically electrolyzing water and a hydrogen compressing stack for electrochemically compressing hydrogen. The water electrolysis stack includes, for example, a water electrolysis cell including an anion (for example, OH— ion) transport type electrolyte membrane. The water electrolysis stack may include a water electrolysis cell including a proton transport type electrolyte membrane. The water electrolysis stack electrolyzes water supplied from the water tank 26 to generate oxygen and hydrogen. The water electrolysis stack is connected to the oxygen tank 20 and supplies high-pressure oxygen to the oxygen tank 20.

The hydrogen generated in the water electrolysis stack is supplied to the hydrogen compressing stack. The hydrogen compressing stack has a proton transport type electrolyte membrane, and electrochemically compresses hydrogen to supply high-pressure hydrogen to the hydrogen tank 18.

In the above-described regenerative fuel cell system, hydrogen and oxygen are circulated between the water electrolysis system and the fuel cell system 10 to be repeatedly used. Therefore, impurities tend to accumulate in the hydrogen circulation path 12 and the oxygen circulation path 14 of the fuel cell system 10 used in the regenerative fuel cell system. Further, in the water electrolysis stack, a trace amount of carbon monoxide and/or a trace amount of carbon dioxide is generated. Carbon monoxide and carbon dioxide generated in the water electrolysis stack are likely to be accumulated in the hydrogen circulation path 12 and the oxygen circulation path 14.

In the fuel cell system 10 shown in FIG. 1, since the impurities accumulated in the hydrogen circulation path 12 and the oxygen circulation path 14 can be discharged by the purging process as described above, when the fuel cell system 10 is applied to a regenerative fuel cell system, the electrical power generation performance of the regenerative fuel cell system can be advantageously maintained for a long period of time.

The disclosure described above can be summarized as follows.

According to an aspect of the present invention, the fuel cell system is provided. The fuel cell system includes the gas circulation path configured to supply the gas that has been discharged from the fuel cell back to the fuel cell, the volume adjuster configured to increase or decrease the volume of the gas in the gas circulation path, the voltage sensor configured to detect the voltage of the fuel cell, the volume control unit configured to control the volume adjuster to increase the volume of the gas, and the estimation unit configured to estimate the impurity amount or the impurity concentration of the gas from the voltage change of the fuel cell due to the increase in the volume of the gas.

In the above-described fuel cell system, the impurity concentration in the gas is decreased by increasing the volume of the gas, and the impurity amount or the impurity concentration can be estimated from the resulting voltage change amount of the fuel cell. Therefore, the fuel cell system can accurately obtain the impurity amount or the impurity concentration during the operation, and can suppress the loss of gas by reducing unnecessary purging.

In the above-described fuel cell system, the gas circulation path may include the gas-liquid separator configured to remove water from the gas that has been discharged, and the volume adjuster may adjust the volume of the gas inside the gas-liquid separator. In this fuel cell system, since the gas-liquid separator is used to adjust the volume of the gas circulation path, the device can be miniaturized and simplified.

In the above-described fuel cell system, the volume adjuster may include the drainage valve that drains water in the gas-liquid separator, and the volume control unit may control the drainage valve to increase the volume of the gas. Since this fuel cell system can realize the function of adjusting the volume of the gas circulation path without making a structural modification, the device can be simplified and the cost can be reduced.

In the above-described fuel cell system, the volume adjuster may include the piston configured to change the volume of the gas-liquid separator and the actuator configured to drive the piston, and the volume control unit may control the actuator to increase the volume of the gas. Since this fuel cell system can generate a sufficient amount of volume change regardless of the amount of water in the gas-liquid separator, it is possible to increase opportunities to estimate the impurity amount or the impurity concentration.

The above-described fuel cell system may further include the purge valve configured to discharge the gas in the gas circulation path to outside, and the purge control unit configured to control the purge valve to discharge the gas in the gas circulation path to the outside when the impurity amount or the impurity concentration of the gas exceeds the predetermined value. This fuel cell system can reduce the amount of gas loss by reducing unnecessary purging.

In the above-described fuel cell system, the purge control unit may adjust the purge amount of the gas based on the impurity amount or the impurity concentration of the gas. The fuel cell system can suppress loss of gas by suppressing the purge amount.

In the fuel cell system described above, the gas may be a hydrogen gas. In the above-described fuel cell system, the gas may be an oxygen gas.

In the above-described fuel cell system, the gas circulation path may be provided to each of the cathode and the anode of the fuel cell, the volume control unit may increase the volume of the gas in the gas circulation path of the cathode and the volume of the gas in the gas circulation path of the anode at different times, and the estimation unit may respectively estimate the impurity amount or the impurity concentration of the gas contained in the gas circulation path of the anode and the impurity amount or the impurity concentration of the gas contained in the gas circulation path of the cathode. In this fuel cell system, the impurity amount or the impurity concentration contained in the gas in the circulation path of the anode and the impurity amount or the impurity concentration contained in the gas in the circulation path of the cathode can be collectively estimated, so that the processing can be speeded up.

Moreover, it should be noted that the present invention is not limited to the disclosure described above, and various configurations may be adopted therein without departing from the essence and gist of the present invention.

1. A fuel cell system comprising:
a gas circulation path configured to supply a gas that has been discharged from a fuel cell back to the fuel cell;
a volume adjuster configured to increase or decrease a volume of the gas in the gas circulation path;
a voltage sensor configured to detect a voltage of the fuel cell; and
one or more processors that execute computer-executable instructions stored in a memory,
wherein the one or more processors execute the computer-executable instructions to cause the fuel cell system to:
control the volume adjuster to increase the volume of the gas; and
estimate an impurity amount or an impurity concentration of the gas from a voltage change of the fuel cell due to an increase in the volume of the gas.

2. The fuel cell system according to claim 1, wherein the gas circulation path comprises a gas-liquid separator configured to remove water from the gas that has been discharged, and
the volume adjuster adjusts the volume of the gas inside the gas-liquid separator.

3. The fuel cell system according to claim 2, wherein the volume adjuster comprises a drainage valve that drains water in the gas-liquid separator, and
the one or more processors cause the fuel cell system to control the drainage valve to increase the volume of the gas.

4. The fuel cell system according to claim 2, wherein the volume adjuster comprises a piston configured to change a volume of the gas-liquid separator and an actuator configured to drive the piston, and
the one or more processors cause the fuel cell system to control the actuator to increase the volume of the gas.

5. The fuel cell system according to claim 1, further comprising a purge valve configured to discharge the gas in the gas circulation path to outside,
wherein the one or more processors cause the fuel cell system to control the purge valve to discharge the gas in the gas circulation path to the outside when the impurity amount or the impurity concentration of the gas exceeds a predetermined value.

6. The fuel cell system according to claim 5, wherein the one or more processors cause the fuel cell system to adjust a purge amount of the gas based on the impurity amount or the impurity concentration of the gas.

7. The fuel cell system according to claim 1, wherein the gas is a hydrogen gas.

8. The fuel cell system according to claim 1, wherein the gas is an oxygen gas.

9. The fuel cell system according to claim 1, wherein the gas circulation path is provided to each of a cathode and an anode of the fuel cell, and
the one or more processors cause the fuel cell system to:
increase the volume of the gas in the gas circulation path of the cathode and the volume of the gas in the gas circulation path of the anode at different times; and
respectively estimate the impurity amount or the impurity concentration of the gas contained in the gas circulation path of the anode and the impurity amount or the impurity concentration of the gas contained in the gas circulation path of the cathode.
